(19) United States
(12) Patent Application Publication
(10) Pub. No.: US 2007/0100102 A1
(43) Pub. Date: May 3, 2007

(54) COPOLYMER BASED ON OLEFINIC SULPHONIC ACIDS

(76) Inventors: Andrea Fenchl, Wasserburg (DE); Christian Spindler, Burghausen (DE); Jurgen Heidlas, Trostberg (DE); Johann Plank, Trostberg (DE)

Correspondence Address: FULBRIGHT & JAWORSKI, LLP, 666 FIFTH AVE, NEW YORK, NY, 10103-3198, US

(21) Appl. No.: 11/551,490

(22) Filed: Oct. 20, 2006

(30) Foreign Application Priority Data
Oct. 29, 2005 (DE) 10 2005 051 906.7

(51) Int. Cl. C08F 230/08; C08F 228/02

(52) U.S. Cl. 526/279; 526/287

(57) ABSTRACT

A copolymer based on olefinic sulphonic acids as monomer component a) and an organosilicone-containing compound as reactive component b) is proposed, for which in particular 2-acrylamido-2-methylpropanesulphonic acid (AMPS®) is suitable as component a) and vinyltrimethoxysilane, vinyltriethoxysilane and trichlorosilane as component b). This copolymer, which may have a molecular weight of from 5,000 to 5,000,000 g/mol, may also comprise further reaction components c) and d) in addition to the two main components for which further reaction components (meth)acrylamides or vinyl ethers are suitable. These copolymers, which are obtainable in particular by precipitation or gel polymerizations, are used in particular in applications in construction chemistry and here especially as water retention agents and fluid loss additives in drilling fluids and for well cementing. The novel copolymers are distinguished by pronounced thermal stability, which is displayed especially under difficult pressure conditions and at high salinities.

### BACKGROUND AND SUMMARY OF THE INVENTION

This application claims priority from German Patent Application 10 2005 051 906.7 filed Oct. 29, 2005, hereby incorporated by reference in its entirety.

The present invention relates to a copolymer based on olefinic sulphonic acids, a process for the preparation thereof and the use thereof.

In general, the so-called rotary method is used for drilling for oil and gas. This method is based substantially on the rotation of the drilling string, at the end of which the drill bit is present. During drilling through the rock, the latter results in the formation of drillings, which accumulate as drilling progresses. In order to prevent problems which may occur in this procedure, a drilling fluid which emerges at the head of the drill bit and flows back to the surface through the annular space between the drill pipe and the rock formation is pumped through the hollow drilling string. The drilling fluid performs, as main functions, the lubrication and cooling of the drill bit, the suspending and discharge of the drillings and finally the stabilization of the borehole to the formation pressure which the surrounding rock exerts.

Oil- and gas-containing formations are usually composed of porous strata, and it is for this reason that the production rate of the oil or gas is also greatly dependent on the permeability of the respective formation. In particular, drilling fluids which form a filter cake of low permeability and in this way prevent the penetration of relatively large amounts of liquids into these formation strata are therefore suitable for drilling through such porous structures. If liquids were to penetrate into the formation, the pores present therein would become blocked and the permeability for oil or gas would deteriorate dramatically. The ability of a drilling fluid to prevent this negative effect is referred to as filtrate control.

The filtrate control is also of great importance in the cementing of a borehole while the so-called casings are introduced into the well and the cement slurry is pumped into the cavity between the formation and the casings of the drill pipe. As a result high hydrostatic pressures are brought to bear on the cement slurries, which press water into the formation. This inevitably leads both to the above-described damage to the formation by blockage and to considerable water loss. In the case of an excessively great release of water into the surrounding rock, the cement slurry required for cementing the well would not completely set and would consequently become permeable to gas and oil so that they can flow from the carrier rock into other formation sections or even to the surface.

It is therefore an aim to ensure that the resulting cement casing in the annular space reaches defined strengths as quickly as possible, and as far as possible no shrinkage should occur during setting, since this would permit the formation of flow channels for gas, oil or water. The desired optimum establishment of the properties of the cement slurry is possible by the addition of special additives. Retardants, accelerators, dispersants and water retention agents may be mentioned as most important members.

The first effective water retention agents which are also still used routinely today were cellulose ethers based on hydroxyethylcellulose and carboxymethylhydroxyethylcellulose. However, a disadvantage of these members is that they lose their activity owing to their thermal instability at well temperatures above 150° C. This was the reason why a very wide range of fully synthetic polymers which can also be used at different temperatures and salinities of the cement slurry were developed as alternatives.

The prior art discloses a multiplicity of polymers which can be used as water retention agents for drilling fluids and cement slurries:

Thus, U.S. Pat. No. 4,555,269 describes cement slurry compositions which contain copolymers and copolymer salts of N,N-dimethylacrylamide and 2-acrylamido-2-methylpropanesulphonic acid having molar ratios between 1:4 and 4:1. These copolymers and salts thereof have a molar mass between 75,000 and 300,000 g/mol.

Additives for cement slurry compositions which contain from 0.2 to 10% by weight of phosphonate side groups are disclosed in U.S. Pat. No. 5,336,316.

European Patent EP 1 033 378 B1 describes polymers which can be used as filtrate reducers in cement slurries and drilling fluids. These polymers are derived from 2-acrylamido-2-methylpropanesulphonic acid (AMPS), an open-chain N-vinylamide and an annular N-vinylamide. By using these polymers in drilling fluids the problem of the non-uniform Theological properties of the drilling fluid after the mixing and after thermal load between 130 and 200° C. is said to be solved.

U.S. Pat. No. 4,708,207 discloses a method for the treatment of underground rock formations, an aminopolycarboxylic acid and a water-soluble organosilicone-containing compound being used. By means of an appropriate treatment, deposits on equipment in the borehole and on the formation are said to be removed.

EP 1 172 412 A1 teaches the use of an aqueous dispersion for improving the adhesion of paints on surfaces. The dispersion is obtained by hydrolysis or condensation and free radical polymerization of a mixture which is obtainable from an organosilane and a vinyl polymer capable of free radical polymerization, in the emulsified state.

Patent Application GB 2 399 364 A discloses a composition which is used for reducing excessive water transport from oil and gas wells. This composition contains a polymer which changes the permeability of the underground rock formation and a hydrolysable organosilicone-containing compound.

The petroleum industry continues to have a need for improved additives and in particular water retention agents which adversely affect the formation of compressive strength, viscosity and stiffening time of a cement slurry as little as possible. In particular, the water retention agents should sustain their activity in a stable manner in saturated salt solution (so-called brines) as occurs when drilling through salt deposits, and in sea water. Moreover, it is necessary for such water retention agents to have good filtrate-reducing properties over a pH and temperature range which is as wide as possible (up to 200° C.) and in addition to be compatible with other additives. Furthermore, the additives should not thicken the cement slurries to an excessive extent, in order to maintain the pumpability thereof, which is particularly important also for drilling fluids.

Although there is a multiplicity of compounds which are suitable for the special application as water retention agents in the petroleum and natural gas sector, the multiplicity of different requirements also illustrate the problem for formulating an optimum cement slurry or drilling fluid.

On the basis of the disadvantages of the prior art and the requirements that suitable drilling additives still have to meet, it was the object of the present invention to provide a novel copolymer which can also be used as a water retention agent and, in this context, in particular meets the requirements, such as formation of compressive strength, viscosity and stiffening time of a cement slurry, set with regard to water retention agents especially in the area of petroleum and natural gas extraction, and enables their use in wide temperature and pH ranges, said water retention agents also being required to be compatible with other additives which are usually used in drilling in relatively deep rock formations.

This object was achieved by a copolymer based on olefinic sulphonic acids of the general formula (I) 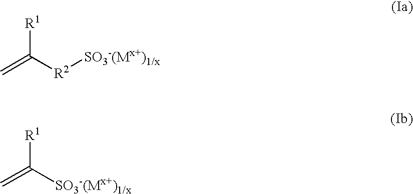
in which
R¹=hydrogen or C₁-C₅-alkyl,
R²=C₁-C₂₀-alkylene, carboxy-C₁-C₂₀-alkylene, carboamido-C₁-C₂₀-alkylene or phenylene,
M=hydrogen, ammonium or a monovalent, divalent or trivalent metal cation and
x=1 to 3
   as monomer component a) and an organosilicone-containing compound of the general formula (II)
   (R³O)_{y}—Si—R⁴_{z} (II)
   in which
R³=H, C₁-C₂₀-alkyl, C₁-C₂₀-alkenyl, C₁-C₂₀-alkynyl, aryl, alkylpolysiloxane oligomer or mixtures thereof,
R⁴=vinyl, allyl, (meth)acryloyl, C₁-C₈-hydroxyalkyl, C₁-C₈-aminoalkyl, C₁-C₈-alkylglycidyl, C₁-C₈-isocyanato or mixtures thereof,
y=1 to 3
z=4-y as reactive component b).

It has proved to be completely surprising that, for example, the action of water-soluble polymers as water retention agents can be significantly improved almost independently of the monomer composition thereof if organosilicone functional groups are incorporated into the polymer. In practice, it has been found that the polymer mixtures according to the invention, especially in salt-containing cement slurries at high temperatures and in combination with other additives, such as, for example, dispersants, are substantially superior to those polymers which have no organosilicone functional groups. Thus, particularly in practical use and especially in association with NaCl-containing cement slurries, it has been found that the copolymers according to the invention result only in a water less which is anyway reduced by at least 50% compared with polymers without organosilicone functional groups.

### DETAILED DESCRIPTION

The present invention envisages in particular that the reactive component b) essential to the invention be either a polymerized constituent of the polymer main chain and/or at least a constituent of a polymer side chain and/or an unpolymerized constituent of the copolymer. The organosilanes may be incorporated covalently into the copolymer, but it is not important whether the organosilane-containing reactant is incorporated into the polymer directly via a polymerizable group, such as, for example, vinyl or (meth)acryloyl or whether free amino and/or hydroxyl groups of the organosilane-containing reactant form condensates with the side groups of the unmodified copolymer after the hydrolysis in the aqueous reaction medium. In any case, it should be stated that even simply mixing the organosilane-containing reactants with the unmodified copolymer also leads to an improved performance of the copolymers according to the invention which is once again true in particular for the water retentivity. The mixing may consist in adding the organosilane-containing reactant directly to the polymer solution after the synthesis or adding to the polymer immediately before use.

Preferably, the copolymer should contain the component a) in proportions of from 5.0 to 99.99% by weight and the component b) in proportions of from 0.01 to 95.0% by weight.

An additional alternative to the claimed copolymer is that it contains, as further reaction component c), a compound of the general formula (III) 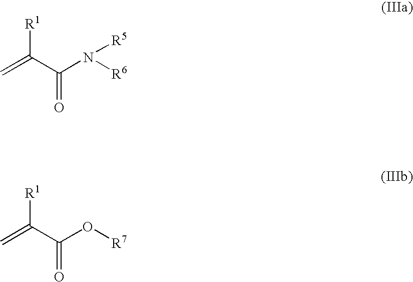
in which
R¹ has the stated meaning,
R⁵, R⁶ and R⁷ independently of one another, denote hydrogen, C₁-C₁₀-alkyl, C₁-C₁₀-aminoalkyl, C₁-C₁₀-hydroxyalkyl or—in the case of a common cyclic linkage of R⁵ and R⁶— —(CH₂)ᵤ—and
u=3 to 7
   it being possible for the proportions of this reaction component c), based on the copolymer, to be up to 60% by weight.

Alternatively or additionally, it is also possible to add, as reaction component d), a vinyl or allyl compound of the general formula (IV) 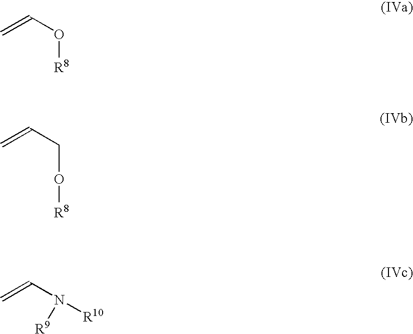
in which
R⁸=C₁-C₁₀-alkyl, C₁-C₁₀-aminoalkyl, C₁-C₂₀-hydroxyalkyl, C₁-C₄-alkyl- or hydroxyl-terminated mono- or poly-C₂/C₃-alkylenoxy (having 1 to 400 alkylenoxy units), C₇-C₂₀-alkylaryl, C₇-C₂₀-hydroxyalkylaryl, C₆-C₁₀-aryl, C₆-C₁₀-hydroxyaryl and
R⁹ and R¹⁰=independently of one another, denote hydrogen, C₁-C₂₀-alkyl, C₁-C₁₀-aminoalkyl, C₁-C₂₀-hydroxyalkyl, C₁-C₄-alkyl- or hydroxyl-terminated mono- or poly-C₂-C₃-alkylenoxy (having 1 to 400 alkylenoxy units), C₇-C₂₀-alkylaryl, C₇-C₂₀-hydroxyalkylaryl, C₆-C₁₀-aryl, carboxy-C₁-C₂₀-alkylene, carbamido-C₁-C₂₀-alkylene, phenylene, C₆-C₁₀-hydroxyaryl or, in the case of a common cyclic linkage of R⁹ and R¹⁰, —(CH2)ᵤ—, in which u has the stated meaning.

This reaction component d) should be involved in the copolymer in proportions of up to 20.0% by weight, preferably up to 10.0% by weight and in particular between 3.0 and 8.0% by weight.

Owing to the possible structural variation with regard to the reactive component a), b), c) and d), the claimed copolymer may cover a relatively broad molecular weight spectrum, but the present invention envisages preferred ranges which are between 5000 and 5 000 000 g/mol. Preferably, the molecular weight should be between 10 000 and 3 000 000 g/mol and particularly preferably between 500 000 and 1 500 000 g/mol.

Preferred members of the reactive component a) are 2-acrylamido-2-methylpropanesulphonic acid (AMPS®), styrenesulphonic acid, vinylsulphonic acid, methacryloylsulphonic acid and salts and mixtures thereof. If, in the case of the reactive component a), M represents a metal cation, in particular sodium and potassium ions are preferred as monovalent metal ions and alkaline earth metal ions, such as, for example, calcium and magnesium ions, are preferred as divalent metal cations; aluminium or iron ions are preferred members of trivalent cations.

If the copolymer according to the present invention is based on a reactive component a) of the general formula (ia) R¹ should be preferably hydrogen and R²=—CO—NH—C(CH₃)₂—CH₂—. In general, AMPS® and suitable salts thereof are regarded as being particularly suitable as reactive component a).

For the component b), the present invention provides vinyltrimethoxysilane, vinyltriethoxysilane, vinyldiethoxysilane, 3-glycidyloxypropyltriethoxysilane, 3-aminopropyltrimethoxysilane, 3-methacryloyloxypropyltrimethoxysilane, trichlorosilane, 3-isocyanatopropyltrimethoxysilane, glycidyloxypropyldimethoxysilane and DYNASILAN HS 2907® of the formula (V) 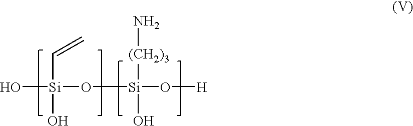
and suitable mixtures thereof as preferred members.

The preferred use of such oligomeric, functionalized polysiloxanes is advisable whenever the organosilane-containing compounds according to general formula (II) are used as members of the reactive component b) in aqueous solution, since partial hydrolysis of the alkoxy groups then takes place.

According to the present invention acrylamide, methacrylamide, N,N-dialkylacrylamide, N,N-dimethylaminoethyl methacrylate, N,N-dimethylaminopropylmethacrylamide and mixtures thereof are proposed as particularly suitable reactants c).

Hydroxybutyl vinyl ether (HBVE), cyclohexyl vinyl ether, polyethylene glycol monovinyl ether, diethylene glycol monovinyl ether, N-vinylformamide, N-vinylacetamide, N-vinylimidazole, N-vinylpyrrolidone and/or N-vinylcaprolactam are preferred members of component d).

A composition in which the reactive component a) is present in proportions of from 5 to 99.95% by weight, the reactive component b) in proportions between 0.01 and 20% by weight, the additional component c) in proportions up to 50% by weight and the unit d) in proportions up to 20% by weight is proposed for the copolymer according to the invention, it being necessary for the individual proportions of the components a), b) and/or c) and/or d) to sum to 100% by weight. Particularly preferred are copolymers which contain the component a) in proportions between 40 and 83% by weight, the component b) in proportions between 0.05 and 10% by weight, the component c) in proportions between 5 and 40% by weight and the component d) in proportions up to not more than 10% by weight.

As already stated in connection with the molecular weight of the copolymer, the structure based on the suitable monomers can be varied widely so that the number of repeating structural units in the copolymers according to the invention is also not limited.

In addition to the copolymer itself, the present application also claims a process for the preparation thereof. In this context, too, the invention is not subject to any substantial limitations. However, according to the invention, mass polymerization, solution polymerization and inverse emulsion polymerization are regarded as being preferred suitable processes for the preparation thereof, suspension polymerization, preparation in an organic continuous phase, but also precipitation polymerizations or gel polymerizations, also being suitable in the context of the present invention.

Solution polymerization is to be regarded as a particularly preferred variant, in which case in particular water is to be used as a suitable solvent.

For the purpose of inverse emulsion polymerization, the respective monomers are first dissolved in the aqueous phase and then emulsified with the aid of a protective colloid in a customary organic solvent, such as, for example, cyclohexane, toluene, heptane, petroleum ether or mineral oils. The polymerization reaction is then initiated with the aid of a commercially available initiator soluble in organic solvents, such as, for example, dibenzoyl peroxide or azobisisobutyronitrile.

The suspension polymerization in an organic continuous phase differs from the inverse emulsion polymerization with regard to the initiator to be chosen, since a water-soluble initiator system is usually used. The polymer particles obtained thereby are often larger than those obtained according to the inverse emulsion polymerization.

If the copolymers according to the invention are synthesized with the aid of precipitation polymerization, water-soluble C₁-C₅-alcohols, and in particular methanol, ethanol or tert-butanol, are particularly suitable as solvents in the context of the present invention. In particular, owing to its low transfer constant, the last-mentioned solvent is particularly suitable for preparing polymers having a high molecular weight. In fact, during the precipitation polymerization, the copolymer is precipitated as a powder, whereupon it can be isolated by simply filtering off.

If high molecular weights are to be achieved, gel polymerization is also particularly suitable: in this preferred alternative process, the monomers are dissolved in the respective solvent, the monomer content of the aqueous solution usually being between 25 and 75% by weight. The subsequent polymerization results in the formation of a high molecular weight gel which can be subsequently comminuted and dried.

All polymerization processes mentioned are initiated in a temperature range between −9 and 120° C., initiation temperatures between +5 and 90° C. being regarded as preferred. The polymerization reactions can be carried out under atmospheric pressure, but also under elevated pressure. In some cases, it may be advantageous to carry out both the initiation and the polymerization in an inert gas atmosphere.

Regarding the initiation, the present invention takes into account numerous variants. Thus, the polymerization can be initiated thermally with the aid of initiators, such as, for example, azo compounds or photochemically, in which case the decomposition of a-substituted carbonyl compounds, such as, for example, benzoin or benzil derivatives, is suitable. Optionally, a photosensitizer may also be added to the respective photosensitive initiators.

As indicated briefly, some of the polymerization processes mentioned as being preferred for the copolymers according to the invention lead to high molecular weights. Lower molecular weights are obtained, for example, if substances having high transfer constants are added to the reaction solution. Polyfunctional amines, such as, for example, tetraethylenepentamine, of alcohols of the series consisting of methanol, ethanol and isopropanol, and mercaptans, such as, for example, mercaptoethanol, but also allyl ethers, are suitable for obtaining products having comparatively low molecular weights in the range up to not more than 500,000 g/mol.

Depending on the process used, the polymerizations may take place with different exothermicity. The evolution of heat at the beginning of the polymerization can be reduced by the addition of suitable moderators, alkylamines being regarded as being particularly suitable.

The copolymers according to the invention can be used in numerous applications in construction chemistry, which the present invention also envisages. In particular, the use as water retention agents is suitable, the use as a fluid loss additive for drilling fluids and for well cementing being regarded as being particularly preferred. In this context, the copolymers are particularly advantageously to be used under conditions with high salt contents and especially in the so-called brines. The respective copolymer according to the invention is used in the individual applications in construction chemistry preferably in amounts of from 0.05 to 5.0% by weight, based in each case on the dry weight of the hydraulic binder used.

In general, the present invention provides novel polymers which, owing to their organosilicone functional groups, have substantial advantages over the polymers known to date, in particular in applications in construction chemistry and here especially in petroleum and natural gas exploration. In particular, the use as a water retention agent and fluid loss additive is advisable since they have pronounced thermal stability and develop their positive effect in well cementing even under difficult pressure conditions and high salinities. The proposed copolymers can be structurally varied within wide ranges with regard to the reactive components a) and b) essential to the invention and moreover can be adapted in a defined manner to specific circumstances by combination with the further components c) and/or d).

The following examples illustrate the advantages of the novel copolymers.

### EXAMPLES

1. Preparation Example, Solution Polymerization:

6.1 g of calcium hydroxide were suspended in 270 g of tap water, and the amounts of monomer a), monomer b), monomer c), and monomer d) stated in Table 1 were added. The pH was adjusted to values between 5 and 11 with a 20% strength sodium hydroxide solution. Thereafter, the reaction solution was flushed with nitrogen and heated to 50 to 80° C. After addition of 7.3 g of sodium peroxodisulphate, the reaction was stirred for 3 hours at the respective reaction temperature. In order to obtain the polymers as powder, the reaction solutions were spray-dried or drum-dried.

2.1 Use Examples, Deep Well Cementing:

### Formulation

| | |
|---|---|
| 700 g | of LaFarge class H cement |
| 276 g | of tap water |
| 3.5 g | of a polymer according to the invention |
| 27 g | of NaCl |

The water was initially introduced into a Warring blender, the cement was then added with the copolymer powder within 15 sec at low speed (4000 rpm) and the mixture was then homogenized at high speed (12 000 rpm) for 35 sec. These cement slurries were aged in an atmospheric consistometer (Chandler Engineering Co., Serial No. 212) at 80° F. over a period of 20 minutes, the Fann rheology of the cement slurries was determined at 80° F. (600-300-200-100-6-3 rpm) and finally said slurries were tested according to API standard for HTHP fluid loss (FL) determination at 80° F.

In Table 1, polymers according to the invention are compared directly with comparative examples without organosilicone functional groups, both with regard to the monomer composition and with regard to the effect. All polymers mentioned were synthesized according to the solution polymerization from preparation example 1. The basic principle of the substantial improvement of fluid loss (FL) control by polymers with organosilane-containing reactants is likewise illustrated in Table 1 by application tests in the particularly demanding NaCl-containing cement slurry.

The NaCl test slurry is a very demanding test slurry in which even proven high performance polymers, such as those according to comparative example 2, achieve poor results. Table 1 shows that the effect of polymers of different monomer compositions is substantially improved even in this cement slurry by the incorporation of organofunctional silanes.

TABLE 1

| No. | Monomer a) | Monomer b) | Monomer c) | Monomer d) | FL |
|---|---|---|---|---|---|
| Comparative example 1 | 30 g AMPS ® | — | — | — | 148 |
| Inventive example 1a | 30 g AMPS ® | 1.5 g Vinyltriethoxysilane | — | — | 68 |
| | | (VTEO) | | | |
| Comparative example 2 | 18 g AMPS ® | — | 12 g DMA | — | 178 |
| Inventive example 2a | 18 g AMPS ® | 0.15 g Vinyltrimethoxysilane | 12 g DMA | — | 76 |
| | | (VTMO) | | | |
| Inventive example 2b | 18 g AMPS ® | 1.5 g Dynasylan ® HS 2907 | 12 g DMA | — | 48 |
| Inventive example 2c | 18 g AMPS ® | 0.3 g 3-Methacroyloxy- | 12 g DMA | — | 62 |
| | | propyltrimethoxysilane | | | |
| Comparative example 3 | 15 g Styrene- | — | 15 g Acrylamide | — | 280 |
| | sulphonic acid | | | | |
| Inventive example 3a | 15 g Styrene- | 0.3 g VTMO | 15 g Acrylamide | — | 124 |
| | sulphonic acid | | | | |
| Comparative example 4 | 15 g AMPS ® | — | 15 g Acrylamide | 5 g Hydroxyethyl | 220 |
| | | | | methacrylate | |
| Inventive example 4a | 15 g AMPS ® | 1.0 g Dynasylan ® HS 2097 | 15 g Acrylamide | 5 g Hydroxyethyl | 106 |
| | | | | methacrylate | |
| Inventive example 4b | 15 g AMPS ® | 1.0 g Dynasylan ® HS 2097 | 15 g Acrylamide | 5 g Hydroxyethyl | 68 |
| | | 0.5 g VTMO | | methacrylate | |
| Comparative example 5 | 19 g AMPS ® | — | 15 g Acrylamide | 0.5 g Hydroxybutyl | 192 |
| | | | | vinyl ether | |
| Inventive example 5a | 19 g AMPS ® | 0.5 g 3-Methacroyloxy- | 15 g Acrylamide | 0.5 g Hydroxybutyl | 76 |
| | | propyltrimethoxysilane | | vinyl ether | |
| Comparative example 6 | 20 g AMPS ® | — | 15 g Acrylamide | — | (no control) |
| Inventive example 6a | 20 g AMPS ® | 0.3 g VTMO | 15 g Acrylamide | — | 124 |
| Comparative example 7 | 19 g AMPS ® | — | 10 g Hydroxyethyl | — | 230 |
| | | | methacrylate | | |
| Inventive example 7a | 19 g AMPS ® | 0.5 g 3-Aminopropyltri- | 10 g Hydroxyethyl | — | 124 |
| | | methoxysilane (hydrolysate) | methacrylate | | |
| Inventive example 7b | 19 g AMPS ® | 0.5 g 3-Glycidyloxypropyl- | 10 g Hydroxyethyl | — | 128 |
| | | trimethyoxysilane | methacrylate | | |
| Inventive example 7c | 19 g AMPS ® | 0.5 g 3-Isocyanatopropyl- | 10 g Hydroxyethyl | — | 143 |
| | | trimethoxysilane | methacrylate | | |
| Comparative example 8 | 15 g Styrene- | — | 15 g | 0.5 g Hydroxybutyl | (no control) |
| | sulphonic acid | | Acrylamide | vinyl ether | |
| Inventive example 8a | 15 g Styrene- | 1.0 g 3-Aminopropyltri- | 15 g | 0.5 g Hydroxybutyl | 114 |
| | sulphonic acid | methoxysilane (hydrolysate) | Acrylamide | vinyl ether | |

2.2 Use Examples, Deep Well Cementing

Table 2 shows various formulations of the respective cement slurries.

A copolymer selected by way of example was compared with an unmodified polymer according to the prior art (comparative polymer 2) in different cements, at various temperatures and in combination with other additives. The versatility of the copolymer according to the invention is illustrated by Table 3.

The dosage of the fluid loss (FL) additive was chosen so that in each case the same fluid loss value is obtained with both polymers. Table 3 makes it clear that up to 3 times the amount of the polymer according to the prior art is required for this purpose in comparison with the polymer according to the invention.

TABLE 2
Composition of the cement slurries and temperatures of
the consistometer ageing, and the fluid loss tests
Slurry no. 1

| | |
|---|---|
| 800 g | Dyckerhoff Class G |
| 352 g | Dist. water |
| X g | Polymer (invention) |
| 1 g | Antifoam^{a)} |
| T = 52° C. | |

Slurry no. 2

| | |
|---|---|
| 800 g | Dyckerhoff Class G |
| 352 g | Dist. water |
| 17 g | Sea salt |
| 4 g | Dispersant^{b)} |
| 4 g | Dispersant^{c)} |
| 1 g | Antifoam^{a)} |
| X g | Polymer (invention) |
| T = 88° C. | |

Slurry no. 3:

| | |
|---|---|
| 700 g | Lafarge Class H |
| 266 g | Tap water |
| 0.5 g | Antifoam^{a)} |
| X g | Polymer (invention) |
| 7 g | Dispersant^{b)} |
| 1.4 g | Retardant^{d)} |
| T = 88° C. | |

Slurry no. 4:

| | |
|---|---|
| 700 g | Lafarge Class H |
| 276 g | Tap water |
| 0.5 g | Antifoam^{a)} |
| X g | Polymer (invention) |
| 27 g | NaCl |
| T = RT | |

Slurry no. 5:

| | |
|---|---|
| 700 g | LaFarge Class H |
| 266 g | Water |
| 13 g | Sea salt |
| 0.5 g | Antifoam^{a)} |
| 7 g | Dispersant^{b)} |
| 1.4 g | Retardant^{d)} |
| X g | Polymer (invention) |
| T = 88° C. | |

The respective amount of polymer according to the invention (“X g”) corresponds to the polymer dosage according to Table 3.
^{a)}Tributyl phosphate
^{b)}Acetone/formaldehyde condensate
^{c)}Formaldehyde/naphthalenesulphonic acid condensate
^{d)}Na lignosulphonate

TABLE 3

| | | Polymer according to example 2a | | | | Comparative example 2 (prior art) | | | | |
|---|---|---|---|---|---|---|---|---|---|---|
| Cement slurry | | Fann rheology | Polymer dosage | | FL | FL | Polymer dosage | | Fann rheology | x-fold dosage |
| Type | No. | [600-30-200-100-6-3] | [% bwoc] | [g] | [ml] | [ml] | [% bwoc] | [g] | [600-30-200-100-6-3] | for same FL |
| Class G | 1 | >300-210-165-113-81-54 | 0.35 | 2.8 | 88 | 106 | 0.42 | 3.36 | >300-206-158-102-18-13 | 1.2-fold |
| | 2 | 246-147-109-65-13-10 | 0.5 | 4.0 | 114 | 114 | 1.0 | 8.0 | >300-218-158-92-17-14 | 2-fold |
| Class H | 3 | 124-67-46-24-2-2 | 0.25 | 1.75 | 90 | 88 | 0.75 | 5.25 | >300-205-142-77-9-6 | 3-fold |
| | 4 | >300-261-199-134-59-65 | 0.4 | 2.8 | 96 | 104 | 0.6 | 4.2 | >300-276-206-128-24-20 | 1.5-fold |
| | 5 | 169-97-70-41-8-7 | 0.35 | 2.45 | 66 | 68 | 0.7 | 4.9 | 264-148-105-62-9-7 | 2-fold |

bwoc = “by weight of cement”

From the comparative fluid loss values (FL), it is clear that substantially less of the polymers according to the invention is required for achieving approximately identical fluid loss values.
2.3 Use Example, Drilling Fluid

The polymers prepared according to preparation example 1 were mixed with a dose of in each case 4 ppb (pounds per barrel) using a Hamilton Beach Mixer (“low” speed) in a sea water drilling fluid, then aged dynamically at 350° F. in a roller passage kiln over a period of 16 hours and tested for HTHP fluid loss determination at 350° F. according to API standard 13B, 2nd edition.

### Drilling Fluid Composition

350 g of tap water
12.7 g of bentonite
9.5 g of deflocculant (AMPS®/acrylic acid copolymer)
6.3 g of polymer (invention)
14.3 g of sea salt
618 g of barite
47.5 g of artificial drilling dust (RevDust®, Milwhite, Inc.)
2 g of sodium hydroxide (pH=10-11)

The drilling fluid rheologies were determined after ageing using a Fann rheometer model 35SA from Baroid Testing Equipment at 120° F.

TABLE 4

| No. | Fann rheology | PV | YP | FL |
|---|---|---|---|---|
| Comparative | 285-197-167-118-57-55 | 88 | 109 | 26 |
| example 2 | | | | |
| Inventive | 231-154-123-89-48-47 | 77 | 77 | 14 |
| example 2a | | | | |
| Comparative | 150-87-69-56-37-35 | 63 | 24 | 42 |
| example 3 | | | | |
| Inventive | 155-104-70-49-42-38 | 53 | 51 | 18 |
| example 3a | | | | |

1-21. (canceled)

22. A copolymer comprising an olefinic sulphonic acid of formula Ia or lb 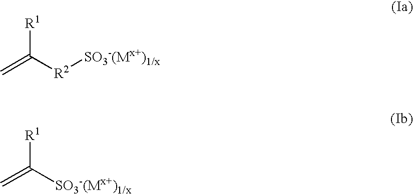
wherein
R¹ is hydrogen or C₁-C₅-alkyl,
R² is C₁-C₂₀-alkylene, carboxy-C₁-C₂₀-alkylene, carboamido-C₁-C₂₀-alkylene or phenylene,
M is hydrogen, ammonium, a monovalent metal cation, a divalent metal cation or a trivalent metal cation, and
x is from 1 to 3
as monomer component a) and an organosilicone-containing compound of formula (II)
(R³O)_{Y}—Si—R⁴_{z} (II)
wherein
R³ is H, C₁-C₂₀-alkyl, C₁-C₂₀-alkenyl, C₁-C₂₀-alkynyl, aryl, alkylpolysiloxane oligomer or mixtures thereof,
R⁴ is vinyl, allyl, (meth)acryloyl, C₁-C₈-hydroxyalkyl, C₁-C₈-aminoalkyl, C₁-C₈-alkylglycidyl, C₁-C₈-isocyanato or mixtures thereof,
y is from 1 to 3, and
z is from 4-y as reactive component b).

23. The copolymer according to claim 22, wherein the reactive component b) is at least one of a polymerized constituent of the polymer main chain or of at least one polymer side chain or an unpolymerized constituent of the copolymer.

24. The copolymer according to claim 22, wherein the copolymer comprises the component a) in an amount of from 5.0 to 99.99% by weight and the component b) in an amount of from 0.01 to 95.0% by weight.

25. The copolymer according to claim 22, wherein a compound of the general formula (III) 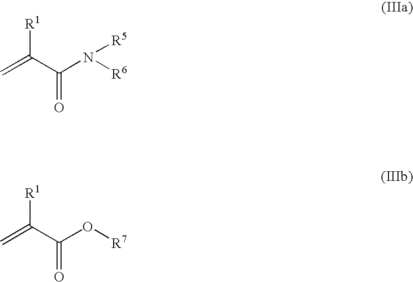
wherein
R₁ is hydrogen or C₁-C₅-alkyl,
R⁵, R⁶ and R⁷ are independently hydrogen, C₁-C10-alkyl, C₁-C10-aminoalkyl, C₁-C₁₀-hydroxyalkyl or—in the case of a common cyclic linkage of R⁵ and R⁶— —(CH₂)ᵤ—and
u is from 3 to 7,
is present as further reaction component c) up to 60% by weight, or a vinyl or allyl compound of formula (IVa), (IVb) or (IVc) 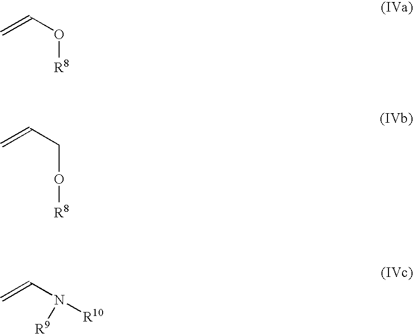
wherein
R⁸ is C₁-C₁₀-alkyl, C₁-Cl₁₀-aminoalkyl, C₁-C₂₀-hydroxyalkyl, C₁-C₄-alkyl- or hydroxyl-terminated mono- or poly-C₂/C₃-alkylenoxy (having 1 to 400 alkylenoxy units), C₇-C₂₀-alkylaryl, C₇-C₂₀-hydroxyalkylaryl, C₆-C₁₀-aryl, C₆-C₁₀-hydroxyaryl and
R⁹ and R¹⁰ are independently hydrogen, C₁-C₂₀-alkyl, C₁-C₁₀-aminoalkyl, C₁-C₂₀-hydroxyalkyl, C₁-C₄-alkyl- or hydroxyl-terminated mono- or poly-C₂-C₃-alkylenoxy (having 1 to 400 alkylenoxy units), C₇-C₂₀-alkylaryl, C₇-C₂₀-hydroxyalkylaryl, C₆-C₁₀-aryl, carboxy-C₁-C₂₀-alkylene, carbamido-C₁-C₂₀-alkylene, phenylene, C₆-C₁₀-hydroxyaryl or, in the case of a common cyclic linkage of R⁹ and R¹⁰, —(CH₂)ᵤ— in which u has the stated meaning,
as d) in an amount of up to 20.0% by weight.

26. The copolymer according to claim 22 having a molecular weight of from 5,000 to 5,000,000 g/mol.

27. The copolymer according to claim 22, wherein the component a) comprises at least one of 2-acrylamido-2-methylpropanesulphonic acid, styrenesulphonic acid, vinylsulphonic acid, methacryloylsulphonic acid or a salt thereof.

28. The copolymer according to claim 22, wherein the component b) comprises at least one of vinyltrimethoxysilane, vinyltriethoxysilane, vinyldiethoxysilane, 3-glycidyloxypropyltriethoxysilane, 3-aminopropyltrimethoxysilane, 3-methacryloyloxypropyltrimethoxysilane, trichlorosilane, 3-isocyanatopropyltrimethoxysilane, glycidyloxypropyldimethoxysilane, or a compound of formula (V)

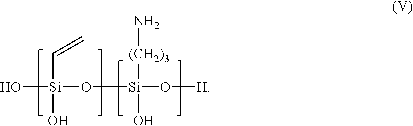

29. The copolymer according to claim 22, wherein the component c) is acrylamide, methacrylamide, N,N-dialkylacrylamide, N,N-dimethylaminoethyl methacrylate, N,N-dimethylaminopropylmethacrylamide or a mixture thereof.

30. The copolymer according to claim 22 comprising as component d) at least one of hydroxybutyl vinyl ether, cyclohexyl vinyl ether, polyethylene glycol monovinyl ether, diethylene glycol monovinyl ether, N-vinylformamide, N-vinylacetamide, N-vinylimidazole, N-vinylpyrrolidone or N-vinylcaprolactam.

31. A process comprising preparing the copolymer according to claim 22, wherein preparation is carried out in the form of a mass, solution or inverse emulsion polymerization, as a suspension polymerization, in an organic continuous phase, as a precipitation polymerization or gel polymerization.

32. A process according to claim 31, wherein in the inverse emulsion polymerization, the reactive components are dissolved in the aqueous phase and are emulsified with the aid of a protective colloid in an organic solvent, and in the reaction is initiated with the aid of an initiator.

33. A process according to claim 31, wherein a water-soluble initiator system is provided for the suspension polymerization.

34. A process according to claim 31, wherein precipitation polymerization is conducted by adding a water-soluble C₁-C₅-alcohol and wherein the copolymer is obtained as a powder.

35. A process according to claim 31, wherein during gel polymerization, the reactive components are initially introduced in aqueous solution in total proportions between 25 and 75% by weight.

36. A process according to claim 31, wherein the polymerization reaction is carried out under superatmospheric pressure.

37. A process according to claim 31, wherein the reaction is carried out under inert gas conditions.

38. A process according to claim 31, wherein the polymerization is initiated at a temperature of from −9 and 120° C.

39. A process according to claims 31, wherein the polymerization is initiated thermally with the aid of initiators or photochemically.

40. A process according to claim 39, wherein the polymerization is initiated by the decomposition of alpha-substituted carbonyl compounds.

41. A process according to claim 31, wherein the molecular weight is established by the addition of polyfunctional amine, an alcohol selected from the group consisting of methanol, ethanol, and isopropanol; a mercaptan or an allyl ether.

42. A composition comprising the copolymer according to claim 22 and a drilling fluid wherein the drilling fluid has a salt content.

43. A composition according to claim 42, wherein the copolymer is present in an amount of from 0.05 to 5.0% by weight, based on the dry weight of a hydraulic binder in the composition.
